(19) United States
(12) Patent Application Publication
(10) Pub. No.: US 2013/0179443 A1
(43) Pub. Date: Jul. 11, 2013

(54) Generating A Pivot Table From An Aggregated Data Set

(71) Applicant: John M. Noel, Matthews, NC (US)

(72) Inventor: John M. Noel, Matthews, NC (US)

(73) Assignee: Bank of America Corporation, Charlotte, NC (US)

(21) Appl. No.: 13/343,787

(22) Filed: Jan. 5, 2012

(51) Int. Cl. G06F 17/30

(52) U.S. Cl. 707/736; 707/E17.005

(57) ABSTRACT

In an exemplary embodiment, a method includes receiving a request to access a data set comprising a plurality of data entries. A data entry comprises one or more data values that are each associated with a field identifier of a plurality of field identifiers. The method may further include, determining the plurality of field identifiers of the data set. A plurality of formatting preferences associated with the plurality of field identifiers may be received. A request to generate a first aggregated data set comprising an aggregation of two or more data entries of the plurality of data entries may be communicated. The aggregation may be based on the plurality of formatting preferences. A pivot table may be generated according to the formatting preferences and the aggregated data set. The first pivot table may comprise at least one column field, a plurality of row fields, and a plurality of table entries.

### TECHNICAL FIELD OF THE INVENTION

This invention relates generally to data analysis and, more specifically, to generating a pivot table from an aggregated data set.

### BACKGROUND OF THE INVENTION

A data set may include numerous data entries. Each entry of a data set may include a series of data values. In some situations, the data of a data set may be voluminous or stored in a complicated format and thus may be difficult to analyze. To facilitate analysis of data from a data set, various data values from the data set may be compiled and presented in a table format, such as a pivot table. A pivot table may facilitate quick and/or efficient analysis of various data recorded within the data set. A pivot table may also allow manipulation of the format in which the data of the data set is presented.

### SUMMARY OF THE INVENTION

In accordance with the teachings of the present disclosure, disadvantages and problems associated with generating pivot tables may be reduced or eliminated.

According to an exemplary embodiment, a method includes receiving a first request to access a data set comprising a first plurality of data entries. A data entry may comprise one or more data values that are each associated with a field identifier of a plurality of field identifiers. The method may further include, determining, by a processor, the plurality of field identifiers of the data set. A plurality of formatting preferences associated with the plurality of field identifiers may be received. A request to generate a first aggregated data set comprising an aggregation of two or more data entries of the first plurality of data entries may be communicated. The aggregation may be based on the plurality of formatting preferences. A first pivot table may be generated, by the processor, according to the formatting preferences and the aggregated data set. The first pivot table may comprise at least one column field, a plurality of row fields, and a plurality of table entries. Each table entry may be associated with a particular column field and a particular row field.

Certain embodiments of the invention may provide one or more technical advantages. A technical advantage of one embodiment includes determining a plurality of field identifiers of a data set and receiving formatting preferences associated with the field identifiers. Another advantage includes aggregating a data set based on formatting preferences associated with the field identifiers of the data set. Another advantage includes generating a pivot table based on the aggregated data set.

Certain embodiments of the present disclosure may include none, some, or all of the above technical advantages. One or more other technical advantages may be readily apparent to one skilled in the art in view of the figures, descriptions, and claims of the present disclosure.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates an example system that facilitates generation of a pivot table from an aggregated data set;

FIG. 2 illustrates an example data set that includes a plurality of data entries;

FIG. 3 illustrates an example user interface for receiving formatting preferences associated with field identifiers of a data set;

FIG. 4 illustrates an example aggregated data set generated by aggregating data values of the data set illustrated in FIG. 2;

FIG. 5 illustrates an example pivot table that may be generated by the system of FIG. 1; and

FIG. 6 illustrates an example method for facilitating the generation of a pivot table from an aggregated data set.

### DETAILED DESCRIPTION OF THE INVENTION

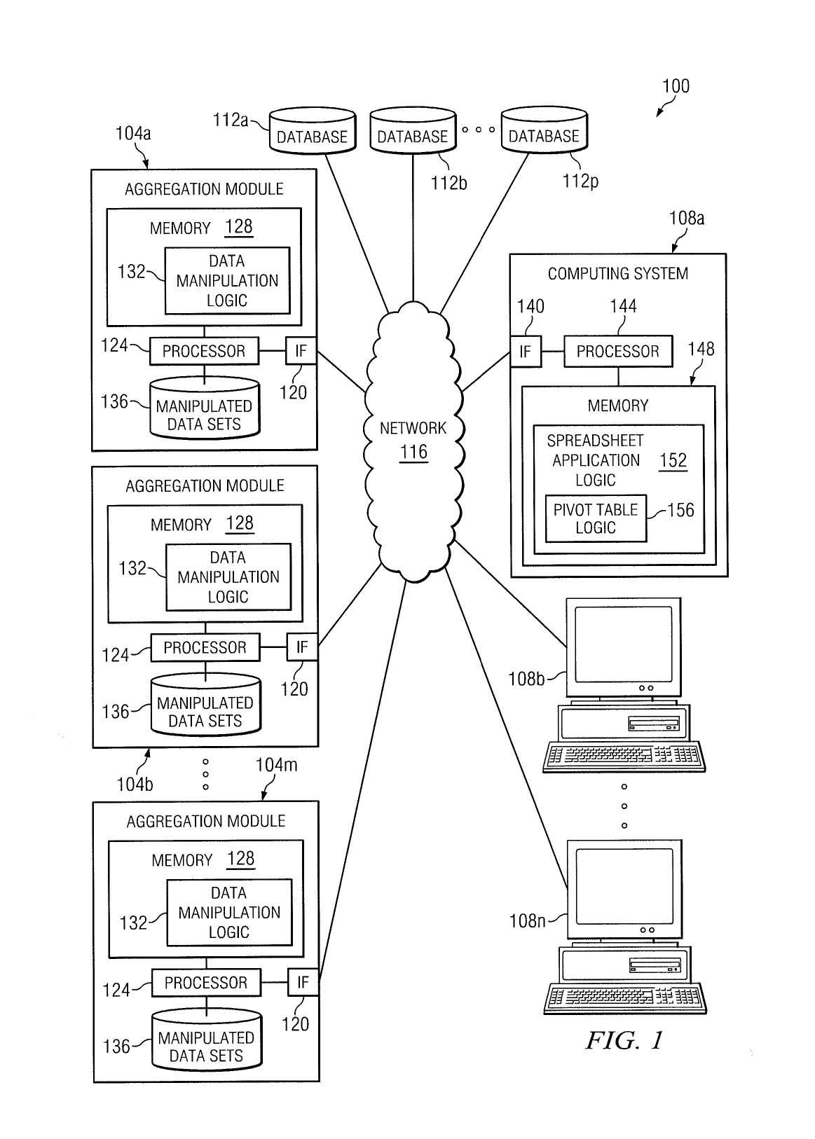

Embodiments of the present invention and its advantages are best understood by referring to FIGS. 1 through 6, like numerals being used for like and corresponding parts of the various drawings.

FIG. 1 illustrates an example system 100 that facilitates generation of a pivot table from an aggregated data set. System 100 includes one or more aggregation modules 104 that communicate with one or more computing systems 108 and one or more databases 112 over one or more networks 116 to facilitate generation of a pivot table from an aggregated data set.

System 100 includes aggregation modules 104a-104m, where m represents any suitable number, that communicate with computing systems 108 or databases 112 through network 116 to aggregate data into data sets and provide information from the data sets to computing systems 108. Aggregation module 104 may include a network server, any suitable remote server, a mainframe, a host computing system, a workstation, a web server, a personal computing system, a file server, or any other suitable device operable to communicate with computing systems 108 and/or databases 112 and receive, process, and/or store data. Aggregation module 104 may also comprise a user interface, such as a display, keyboard, mouse, or other appropriate terminal equipment. In some embodiments, aggregation module 104 may execute any suitable operating system such as IBM's zSeries/Operating System (z/OS), MS-DOS, PC-DOS, MAC-OS, WINDOWS, UNIX, OpenVMS, or any other appropriate operating system, including future operating systems. The functions of aggregation module 104 may be performed by any suitable combination of one or more servers or other components at one or more locations. In the embodiment where aggregation module 104 is a server, the server may be a private server, and the server may be a virtual or physical server. The server may include one or more servers at the same or remote locations. Also, aggregation module 104 may include any suitable component that functions as a server.

System 100 also includes computing systems 108a-108n, where n represents any suitable number, that communicate with aggregation modules 104 or databases 112 through network 116 to generate data sets and receive information from the generated data sets. Computing system 108 may include a personal computing system, a workstation, a laptop, a wireless or cellular telephone, an electronic notebook, a personal digital assistant, or any other device (wireless, wireline, or otherwise) capable of receiving, processing, storing, and/or communicating information with other components of system 100. Computing system 108 may also comprise a user interface, such as a display, keyboard, mouse, or other appropriate terminal equipment.

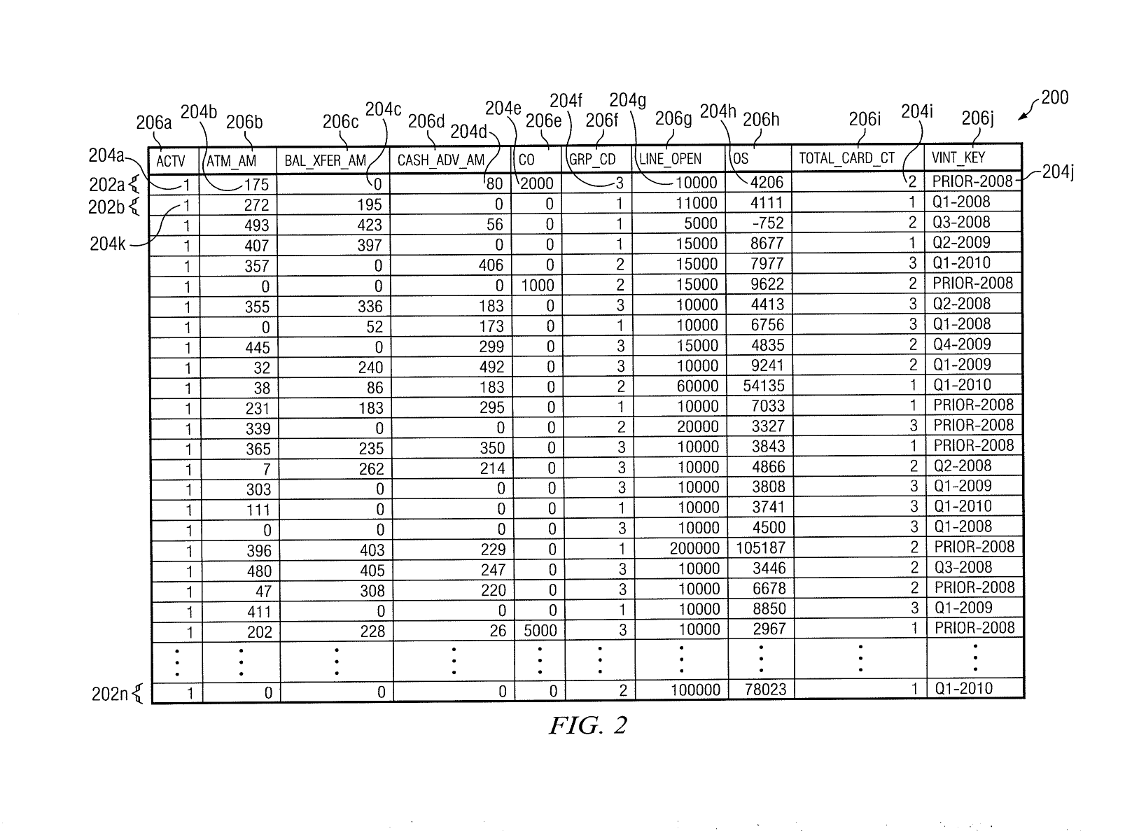

System 100 further includes databases 112a-112p, where p represents any suitable number, that communicate with aggregation modules 104 or computing systems 108 through network 116. Database 112 stores, either permanently or temporarily, one or more data sets (described in more detail in relation to FIG. 2). Database 112 includes any one or a combination of volatile or non-volatile local or remote devices suitable for storing information. For example, database 112 may include random access memory (RAM), read-only memory (ROM), magnetic storage devices, optical storage devices, or any other suitable information storage device or combination of these devices.

Network 116 represents any suitable network operable to facilitate communication between the components of system 100, such as aggregation modules 104, computing systems 108, and databases 112. Network 116 may include any interconnecting system capable of transmitting audio, video, signals, data, messages, or any combination of the preceding. Network 116 may include all or a portion of a public switched telephone network (PSTN), a public or private data network, a local area network (LAN), a metropolitan area network (MAN), a wide area network (WAN), a local, regional, or global communication or computing system network, such as the Internet, a wireline or wireless network, an enterprise intranet, or any other suitable communication link, including combinations thereof, operable to facilitate communication between the components.

In particular embodiments, system 100 may facilitate the generation of a pivot table from an aggregated data set. Aggregation module 104 may be operable to access one or more data sets stored by database 112. In particular embodiments, a data set stored by aggregation module 104 may be a manipulated data set. Aggregation module 104 may filter, combine, or otherwise manipulate the data of a data set to generate a manipulated data set. The manipulated data set is then stored in manipulated data sets database 136. Computing system 108 may receive information (e.g., through a user interface) that identifies a data set stored by aggregation module 104. Computing system 108 may communicate a request to access the identified data set. The data set may be accessed and a plurality of field identifiers of the data set may be determined. A field identifier is a description of one or more values associated with the field identifier. As an example, a data set may include a field identifier “balance” that is associated with various entries of the data set that each contain the amount of an account balance.

Computing system 108 may provide the field identifiers to a user. The user provides formatting preferences associated with the field identifiers. Computing system 108 then communicates a request to aggregation module 104 to generate an aggregated data set from the manipulated data set based on the formatting preferences provided by the user. Aggregation module 104 generates the aggregated set by combining and/or filtering information from the identified data set. In particular embodiments, the size (i.e., the amount of memory consumed by) aggregated data set is less than the size of the identified data set. The aggregated data set may be communicated to computing system 108. Computing system 108 may then generate a pivot table based on the formatting preferences provided by the user and the aggregated data set.

Particular embodiments of the present disclosure provide relatively quick and efficient means for generating a pivot table. Based on the formatting preferences received by computing system 108, system 100 can generate an aggregated data set that is smaller than the underlying data set (i.e., the data set used to generate the aggregated data set) because information that is not needed for the pivot table is not included within the aggregated data set. Moreover, two or more data values of the underlying data set may be combined based on the provided formatting preferences. Because the aggregated data set is relatively small, the resources used to transmit the aggregated data set to the computing system 108 may be reduced. Moreover, because the aggregated data set includes values that have been aggregated prior to generation of the pivot table, the pivot table may be generated relatively quickly. In particular embodiments, the speed of the process may be further increased by taking a random sampling of the underlying database during generation of the aggregated data set. This allows a user to build a pivot table quickly using a small sample size of a large data set and then use a larger sample size once the user has verified that the pivot table has been generated as desired.

A component of system 100 may include an interface, logic, memory, and/or other suitable element. An interface receives input, sends output, processes the input and/or output and/or performs other suitable operations. An interface may comprise hardware and/or software. Logic performs the operation of the component, for example, logic executes instructions to generate output from input. Logic may include hardware, software, and/or other logic. Logic may be encoded in one or more tangible media, such as a computing system-readable medium or any other suitable tangible medium, and may perform operations when executed by a computing system. Certain logic, such as a processor, may manage the operation of a component. Examples of a processor include one or more computing systems, one or more microprocessors, one or more applications, and/or other logic.

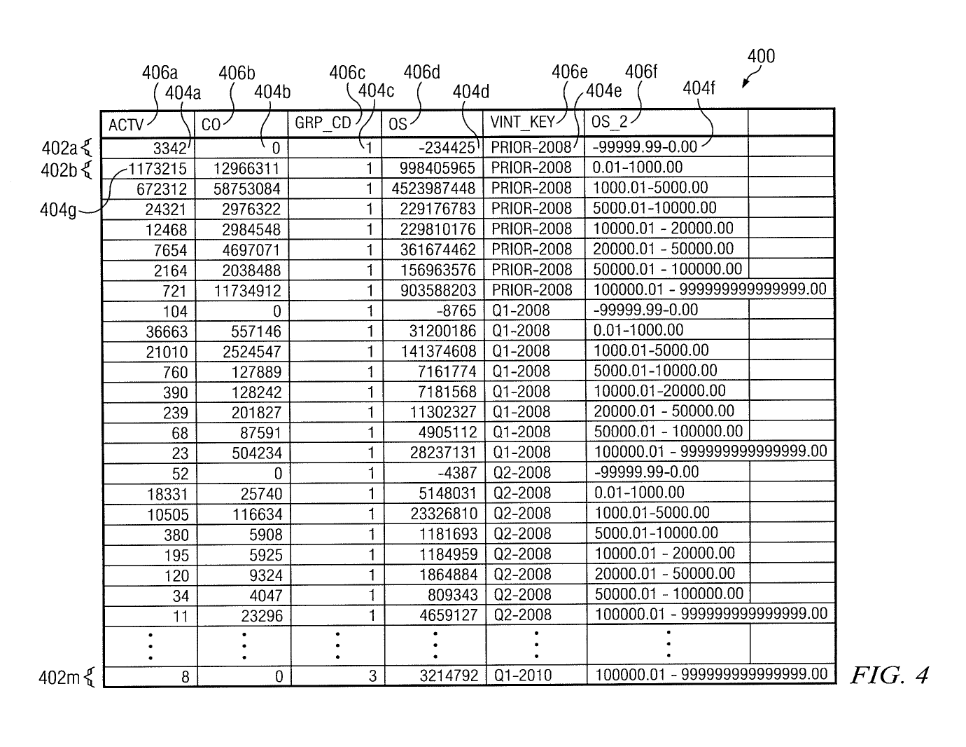

As an example, aggregation module 104 includes one or more network interfaces 120, one or more processors 124, one or more memories 128, and one or more manipulated data sets databases 136 (described in further detail in connection with FIGS. 2 and 4) that collectively facilitate the generation of a pivot table from an aggregated data set.

Network interface 120 represents any suitable device operable to receive information from network 116, transmit information through network 116, perform processing of information, communicate with other devices, or any combination of the preceding. For example, network interface 120 may request data from databases 112. As another example, network interface 120 may receive requests from computing system 108 and communicate the results of the requests to computing system 108. Network interface 120 represents any port or connection, real or virtual, including any suitable hardware and/or software, including protocol conversion and data processing capabilities, to communicate through a LAN, WAN, or other communication system that allows aggregation module 104 to exchange information with network 116, computing systems 108, databases 112, or other components of system 100.

Processor 124 communicatively couples to network interface 120, memory 128, and manipulated data sets database 136 and controls the operation and administration of aggregation module 104 by processing information received from network interface 120, memory 128, and manipulated data sets database 136. Processor 124 may be a programmable logic device, a microcontroller, a microprocessor, any suitable processing device, or any suitable combination of the preceding. Processor 124 includes any hardware and/or software that operates to control and process information. For example, processor 124 executes data manipulation logic 132 to control one or more operations of aggregation module 104.

Memory 128 stores, either permanently or temporarily, data, operational software, or other information for processor 124. Memory 128 includes any one or a combination of volatile or non-volatile local or remote devices suitable for storing information. For example, memory 128 may include RAM, ROM, magnetic storage devices, optical storage devices, or any other suitable information storage device or a combination of these devices. In the illustrated embodiment, memory 128 includes data manipulation logic 132. Data manipulation logic 132 represents any suitable set of logic, rules, algorithms, code, tables, and/or other suitable instructions embodied in a computing system-readable storage medium for performing the described functions and operations of aggregation module 104. While illustrated as including a particular module, memory 128 may include any suitable information for use in the operation of aggregation module 104.

Manipulated data sets database 136 stores, either permanently or temporarily, one or more data sets. In particular embodiments, manipulated data sets database 136 may store data sets that are manipulated versions of data sets stored in database 112. Manipulated data sets database 136 includes any one or a combination of volatile or non-volatile local or remote devices suitable for storing information. For example, manipulated data sets database 136 may include RAM, ROM, magnetic storage devices, optical storage devices, or any other suitable information storage device or combination of these devices.

As another example, computing system 108 includes one or more network interfaces 140, one or more processors 144, and one or more memories 148 that collectively facilitate generation of a pivot table from an aggregated data set.

Network interface 140 represents any suitable device operable to receive information from network 116, transmit information through network 116, perform processing of information, communicate with other devices, or any combination of the preceding. For example, network interface 140 may communicate requests to aggregation module 104 and receive the results of those requests. Network interface 140 represents any port or connection, real or virtual, including any suitable hardware and/or software, including protocol conversion and data processing capabilities, to communicate through a LAN, WAN, or other communication system that allows computing system 108 to exchange information with network 116, aggregation modules 104, databases 112, or other components of system 100.

Processor 144 communicatively couples to network interface 140, and memory 148 and controls the operation and administration of computing system 108 by processing information received from network interface 140 and memory 148. Processor 144 may be a programmable logic device, a microcontroller, a microprocessor, any suitable processing device, or any suitable combination of the preceding. Processor 144 includes any hardware and/or software that operates to control and process information. For example, processor 144 executes spreadsheet application logic 152 to control one or more operations of computing system 108.

Memory 148 stores, either permanently or temporarily, data, operational software, or other information for processor 144. Memory 148 includes any one or a combination of volatile or non-volatile local or remote devices suitable for storing information. For example, memory 148 may include RAM, ROM, magnetic storage devices, optical storage devices, or any other suitable information storage device or a combination of these devices. In the illustrated embodiment, memory 148 includes spreadsheet application logic 152 and pivot table logic 156. Spreadsheet application logic 152 and pivot table logic 156 represent any suitable set of logic, rules, algorithms, code, tables, and/or other suitable instructions embodied in a computing system-readable storage medium for performing the described functions and operations of computing system 108. In the illustrated embodiment, pivot table logic 156 is embedded within spreadsheet application logic 152. In other embodiments, pivot table logic may reside in memory 148 independent of spreadsheet application logic 152. In particular embodiments, spreadsheet application logic 152 and pivot table logic 156 may be operable to communicate with each other and/or may each be able to execute one or more functions on behalf of the other. While illustrated as including a particular module, memory 148 may include any suitable information for use in the operation of computing system 108.

In some embodiments, one or more components of system 100 may be owned and/or operated by an enterprise. An enterprise may represent any individual, business, or organization. One example of an enterprise may include a financial institution. A financial institution may include any individual, business, or organization that engages in financial activities, which may include, but are not limited to, banking and investment activities such as maintaining accounts (e.g., transaction accounts, savings accounts, credit accounts, investment accounts, insurance accounts, portfolios, etc.), receiving deposits, crediting accounts, debiting accounts, extending credit to account holders, purchasing securities, providing insurance, and supervising a customer's portfolio.

In operation, computing system 108 is operable to receive a request to access a data set stored in manipulated data sets database 136. The data set may comprise a plurality of data entries. A data entry may comprise one or more data values that are each associated with a field identifier of a plurality of field identifiers. Computing system 108 is operable to determine the plurality of field identifiers of the data set. Computing system 108 is operable to receive a plurality of formatting preferences associated with the plurality of field identifiers of the data set. Computing system 108 is operable to communicate to aggregation module 104 a request to generate an aggregated data set comprising an aggregation of two or more data entries of the plurality of data entries. Aggregation module 104 is operable to aggregate the data set based on the plurality of formatting preferences received from computing system 108. Computing system 108 is operable to generate a pivot table according to the formatting preferences and the aggregated data set. The pivot table may comprise at least one column field, a plurality of row fields, and a plurality of table entries. Each table entry may be associated with a particular column field and a particular row field.

Modifications, additions, or omissions may be made to system 100 without departing from the scope of the invention. For example, one or more components of aggregation module 104 may be included in computing system 108. As another example, one or more components of computing system 108 may be included in aggregation module 104. Additionally, system 100 may include any number of aggregation modules 104, computing systems 108, databases 112, networks 116, or other components. Any suitable logic may perform the functions of system 100 and the components within system 100.

FIG. 2 illustrates an example data set 200 that includes a plurality of data entries 202a-202n, where n represents any suitable number. Each data entry 202 may include a plurality of data values 204. As depicted, data entry 202a includes data values 204a-204j, data entry 202b includes the series of data values beginning with 204k, and so on. A data value 204 may be associated with a field identifier 206. For example, data value 204 may indicate a value of the field identifier 206 associated with the data value 204. As depicted, data entry 204a is associated with field identifier 206a that has the value of “ACTV.” For each data value 204 associated with field identifier 206a, the data value describes the number of active accounts corresponding to that particular data entry.

Any suitable field identifier 206 may be used. In the embodiment depicted, field identifiers 206b-206j respectively describe an amount of money withdrawn from an ATM over a particular period (“ATM_AM”), an amount of money transferred from an outside account over a particular period (“BAL_XFER_AM”), an amount of money received as a cash advance over a particular period (“CASH_ADV_AM”), an amount of money charged off (“CO”), a group code (“GRP_CD”), a credit limit (“LINE_OPEN”), an outstanding balance (“OS”), a number of cards (“TOTAL_CARD_CT”), and a date of account opening (“VINT_KEY”). As depicted, each field identifier 206 has an associated data value 204 in each entry 202. In particular embodiments, an entry may only have data values 204 for some of the field identifiers 206.

Data set 200 may represent a data set or a manipulated data set and may be stored in database 112 or manipulated data sets database 136. Data set 200 may be stored in any suitable manner. In some embodiments, the data of data set 200 is compressed and stored in database 112 according to a database format, such as a Standard Query Language (SQL), MICROSOFT ACCESS®, MICROSOFT EXCEL®, Hypertext Markup Language (HTML), text, or other database format.

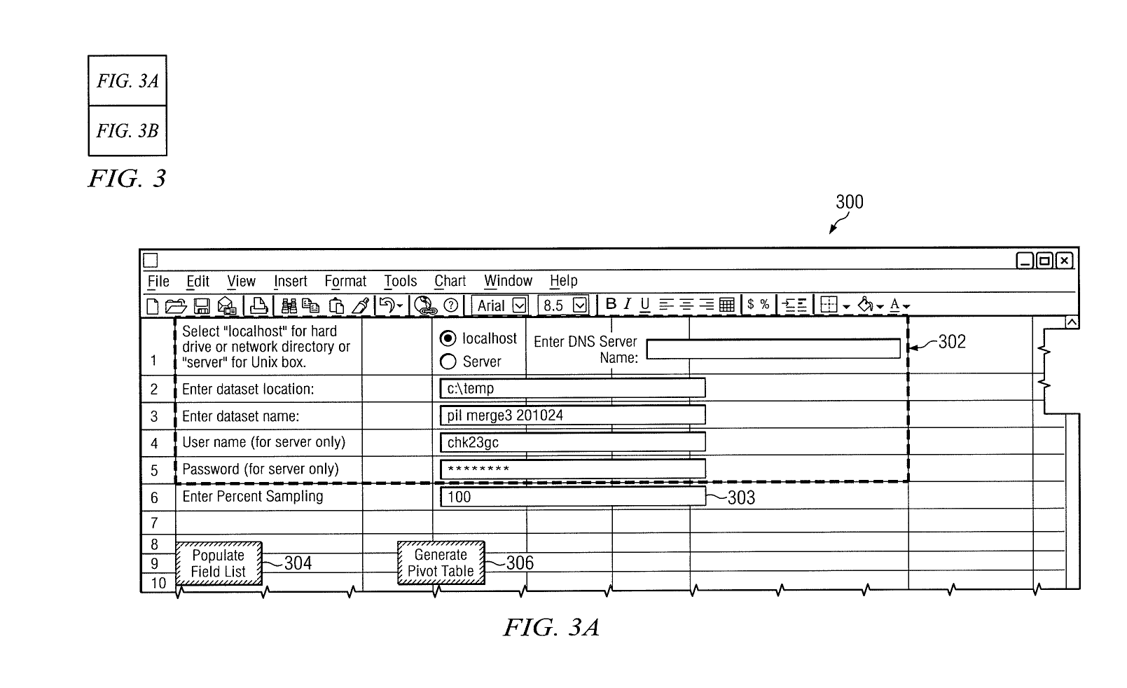

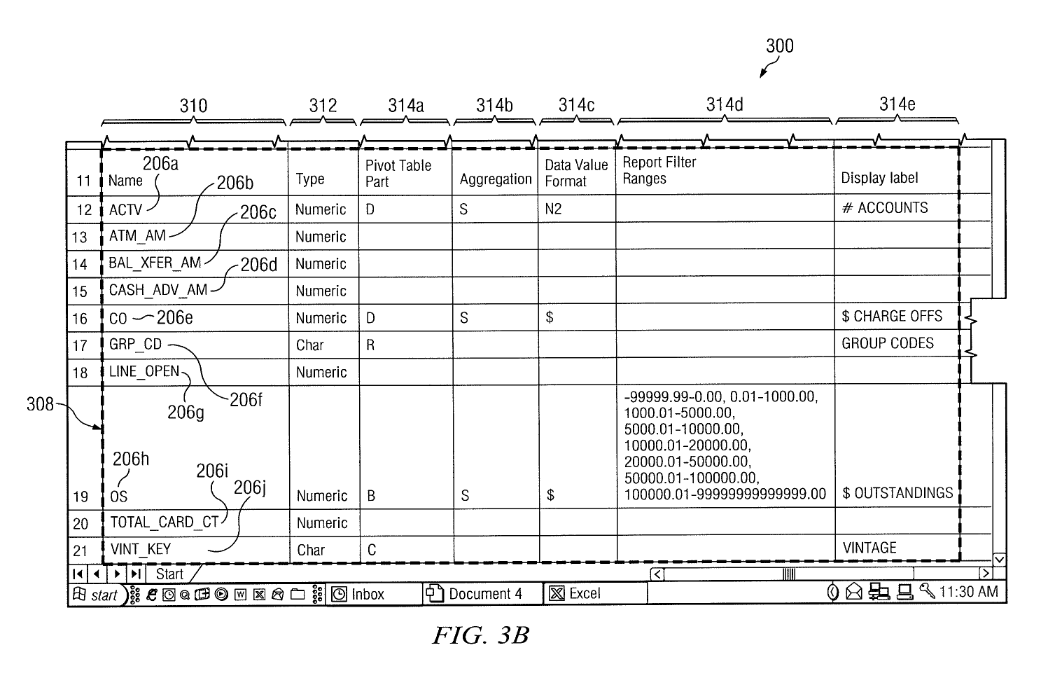

FIG. 3 illustrates an example user interface 300 for receiving formatting preferences associated with field identifiers of a data set. In particular embodiments, user interface 300 may be implemented by computing system 108 executing pivot table logic 156. In the embodiment depicted, user interface 300 includes a data set identification area 302, a sampling size field 303 (described in connection with FIG. 4), a populate field list button 304, a generate pivot table button 306, and a formatting preference area 308.

A user may enter information into data set identification area 302. The information may allow computing system 108 to identify the location of a data set. Data set identification area 302 may allow a user to indicate “localhost” if the manipulated data set is stored at computing system 108 or “server” if the data set is stored at a remote location, such as aggregation module 104. Data set identification area 302 may also include fields for a Domain Name System (DNS) server name (used if server is selected), a location (e.g., a folder identifier) of the data set, the name of the data set file, and a user name and password if access to the system that stores the data set requires log-in information.

Once data set identification information has been entered into data set identification area 302, a request to access the data set may be initiated by pressing the populate field list button 304 (e.g., by a mouse click). Computing system 108 is operable to detect the pressing of button 304 and access the identified data set. In a particular embodiment, the identified data set is stored in memory 148. For example, the data set may be located within a spreadsheet or other file stored in memory 148. In other embodiments, the identified data set may be stored remotely from computing system 108, such as within database 112 or aggregation module 104. In particular embodiments, if the identified data set is stored remotely from computing system 108, a request to access the identified data set may be generated and communicated to the remote system (e.g., aggregation module 104) that stores the identified data set. The identified data set is accessed and computing system 108 determines (in any suitable manner) one or more field identifiers 206 of the identified data set. For example, in particular embodiments, aggregation module 104 may identify the one or more field identifiers 206 and communicate them to computing system 108. In some embodiments, a type of each field identifier may also be determined. A field identifier type may describe a format of the data values 204 associated with the field identifier. For example, a value of a field identifier type may be numeric, char (e.g., a string of characters), or other suitable value.

After the field identifiers 206 are determined, computing system 108 may display the field identifiers 206. For example, in the embodiment depicted, field identifiers 206 are displayed within formatting preference area 308 of user interface 300. In the embodiment depicted, formatting preference area 308 includes a field identifier field 310 associated with the field identifiers 206, a field identifier type field 312 associated with the types of the field identifiers, and formatting preference fields 314 associated with formatting preferences for the field identifiers 206.

After the field identifiers 206 are displayed, a user may enter one or more formatting preferences for one or more of the field identifiers 206. The formatting preferences determine the appearance of a pivot table that will be generated from data associated with the field identifiers. If no formatting preferences are entered for a particular field identifier 206, than data values associated with that field identifier will not be included in the pivot table.

Formatting preference fields 314 may include any suitable formatting preferences. For example, in the embodiment depicted, formatting preference fields 314 include pivot table part 314a, aggregation type 314b, data value format type 314c, report filter ranges 314d, and display label 314e.

A pivot table part 314a specifies what portion of the pivot table the field identifier will be associated with. Any suitable means for indicating the pivot table part 314a may be used. In the embodiment depicted, pivot table part 314a values may be report filter (“R”), column (“C”), data row (“D”), or both data and report filter (“B”). A report filter is a global filter on the data displayed by the pivot table. For example, a pivot table may display an amount of sales per month broken by several different salesmen. If a report filter includes particular regions, then only sales made in one or more particular regions selected by the report filter will be displayed. Thus, if a particular region is deselected, data pertaining to sales in that region may be omitted in the sales per month figures displayed by the pivot table. A column is a column of the pivot table. A data row is a row of the pivot table.

An aggregation type 314b describes how a plurality of values will be aggregated to form a value that is displayed by the pivot table. An aggregation type 314b may have any suitable value such as sum (depicted as “S”), average, count (e.g., the number of times a particular value appears), minimum, maximum, range, mode, median, or other suitable preference.

A data value format type 314c describes the display format of an aggregated data value displayed by the pivot table. A data value format may have any suitable value, such as dollar format (“$”), numeric with commas and two decimal places (“N1”), numeric with commas and no decimals (“N2”), or other suitable format.

Report filter ranges 314d may be used when the pivot table part 314a of a field identifier 206 is specified as both a report filter and a data row (“B”). The report filter ranges 314d specify the various filtering ranges that the report filter of the pivot table will have. In some embodiments, the report filter ranges 314d may span the entire spectrum of data values associated with the field identifier 206 that corresponds to the specified report filter ranges 314d.

A display label 314e specifies how the field identifier 206 will be identified on the pivot table. In some data sets, the field identifiers 206 may have obscure or confusing names. Accordingly, the display label 314e (instead of the field identifier 206) may be displayed in the pivot table to facilitate comprehension of the data presented by the pivot table.

FIG. 4 illustrates an example aggregated data set 400 generated by aggregating data values of data set 200. Data set 400 includes a plurality of data entries 402a-402m, where m represents any suitable number. Each data entry 402 may include one or more data values 404. As depicted, data entry 402a includes data values 404a-404f, data entry 402b includes the series of data values beginning with 404g, and so on. A data value 404 may be associated with a field identifier 406. For example, data value 404 may indicate a value that is described by a field identifier 406 associated with the data value 404.

In particular embodiments, one or more field identifiers 406 of aggregated data set 400 may correspond to (e.g., may be equivalent with) one or more field identifiers 206 of data set 200. For example, field identifier 406a corresponds to field identifier 206a, field identifier 406b corresponds to field identifier 206e, field identifier 406c corresponds to field identifier 206f, field identifier 406d corresponds to field identifier 206h, and field identifier 406e corresponds to field identifier 206j. In particular embodiments, aggregated data set 400 may include one or more field identifiers 406 that are not included in data set 200. For example, field identifier 406f is not included in data set 200. In particular embodiments, additional field identifiers, such as 406f, may be created based on one or more of the formatting preferences associated with the field identifiers 206 received from the user. In a particular embodiment, if report filter ranges are provided for a particular field identifier 206, a new field identifier 406 (i.e., one not included in data set 200) is created and included in aggregated data set 400. For example, report filter ranges 314d corresponding to field identifier 206h were included in formatting preference area 308. Accordingly, field identifier 406f is created and included within aggregated data set 400 when aggregated data set 400 is generated. The data values 404 that may be associated with field identifier 406f are the report filter ranges 314d specified for field identifier 206h in the formatting preference area 308. Each data entry 402 may include a data value 404 associated with the new field identifier 406f that identifies the range into which the data value associated with the field identifier 406d (i.e., the field identifier that corresponds to field identifier 206h) falls.

In some embodiments, an aggregated data set 400 may include less field identifiers 406 than the data set 200 from which it was generated. In particular embodiments, if the formatting preferences corresponding to a field identifier 206 are empty when data set 200 is aggregated, the field identifier 206 will not have a corresponding field identifier 406 in the aggregated data set 400. Accordingly, each data value 204 associated with that field identifier 206 is not included in the aggregated data set 400. For example, in the embodiment depicted, formatting preferences for 206b, 206c, 206d, 206g, and 206i are blank in formatting preference area 308, and thus these field identifiers do not have corresponding field identifiers 406 in aggregated data set 400. Thus, by only including data for the field identifiers 206 for which explicit formatting preferences have been received, the size of aggregated data set 400 may be reduced relative to the size of data set 200.

In particular embodiments, two or more data entries 202 of data set 200 may be combined into a single data entry 402 of aggregated data set 400 based on the received formatting preferences. Thus, in particular embodiments, data set 200 may be aggregated to form aggregated data set 400 based on the information that will be presented in the pivot table that will be generated. Accordingly, the amount of memory needed to store aggregated data set 400 may be smaller (in some cases much smaller) than the memory needed to store data set 200. As an example, in the embodiment depicted, each data entry 402 is formed by aggregating various data entries 202 of data set 200. In the embodiment depicted, various data entries 202 have been aggregated based on their group code, vintage key, and range of outstanding balance. For example, data entry 402a is an aggregate of each data entry 202 that has a group code equal to 1, a vintage key equal to prior to 2008, and an outstanding balance between −$99,999.99 and $0.00. As another example, data entry 402b is an aggregate of each data entry 202 that has a group code equal to 1, a vintage key equal to prior to 2008, and an outstanding balance between $0.01 and $1000.00.

In some embodiments, only a portion (i.e., sampling) of data entries 202 are used to form aggregated data set 400. In a particular embodiment, the size of the portion is determined by the value of sample size field 303. For example, sample size field 303 may specify a percentage of the data entries 202 of data set 200 that will be included in aggregated data set 400. In some embodiments, a random sampling of the data entries 202 of data set 200 may be used to form aggregated data set 400. In particular embodiments, after a pivot table is generated with a small sample size 303, a user may inspect the pivot table, determine that the formatting is correct, and then generate another aggregation data set and pivot table using a larger sample size.

Filtering, aggregating, and/or sampling the data values 204 of data set 200 to form aggregated data set 400 facilitates the fast and efficient generation of a pivot table by reducing the size of the aggregated data set 400 that forms the basis for the pivot table. For example, in some embodiments, generation of a pivot table may include transferring an aggregated data set 400 to computing system 108. Due to the reduced size of aggregated data set 400, the necessary data may be transferred more quickly. In addition, if an aggregated data set 400 (as opposed to the underlying data set 200) forms the basis for the pivot table, a lookup operation may be all that is required to determine a value of a pivot table entry (as opposed to a series of calculations based on multiple data entries 202). Thus, adjustment of a pivot table may be faster and more efficient when it is based on an aggregated data set 400.

Aggregated data set 400 may be stored at any suitable location, such as manipulated data sets database 136 or computing system 108. Aggregated data set 400 may be stored in any suitable manner. In some embodiments, the information represented by aggregated data set 400 is compressed according to a database format, such as an SQL, MICROSOFT ACCESS®, MICROSOFT EXCEL®, HTML, text, or other database format.

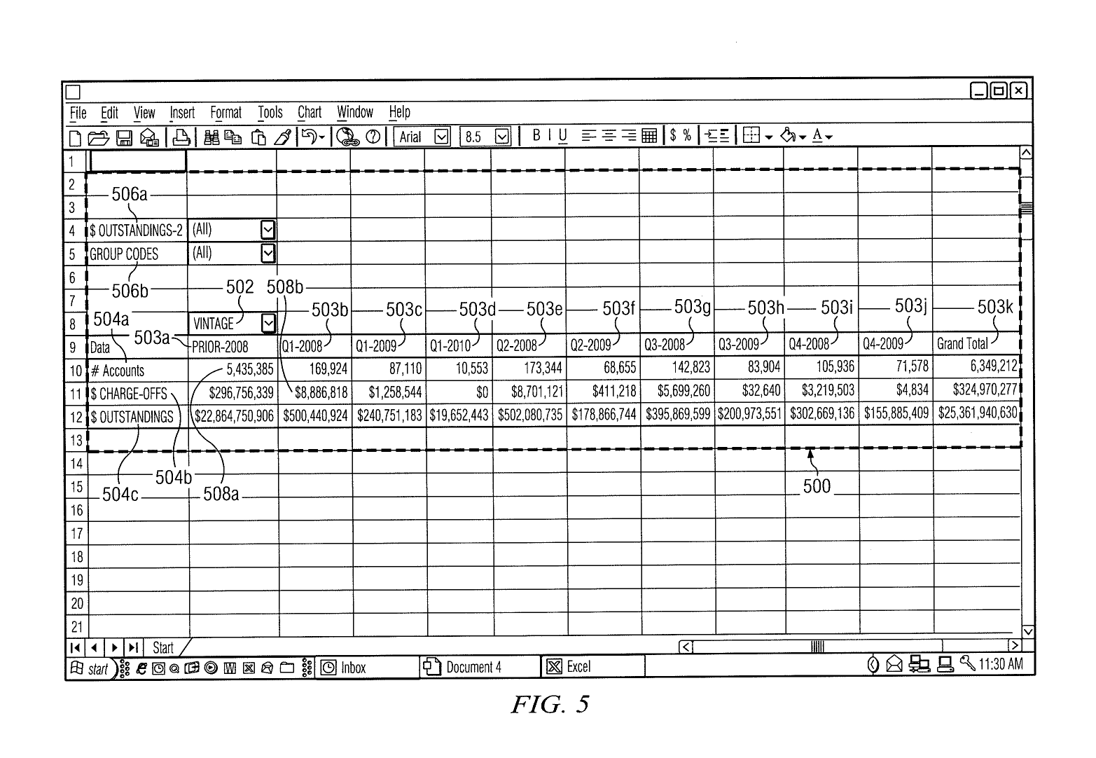

FIG. 5 illustrates an example pivot table 500 that may be generated by system 100 of FIG. 1. Pivot table 500 provides a user-friendly presentation of data from aggregated data set 400. Pivot table 500 may be generated according to the formatting preference fields 314 associated with field identifiers 206. In particular embodiments, pivot table 500 may include one or more columns, rows, and/or report filters for field identifiers 206 based on the specified values of pivot table parts 314a for the respective field identifiers 206. In some embodiments, the field identifiers may be aggregated and/or formatted based on the specified values of aggregation type 314b, data value format type 314c, and/or display label 314e.

As an example, in the embodiment depicted, pivot table 500 includes a column field 502 that corresponds to field identifier 406e of aggregated data set 400 (based on the value of “C” entered for field identifier 206j in FIG. 3). In the embodiment depicted, column field 502 is associated with various sub-column fields 503. In particular embodiments, if the formatting preferences associated with the field identifiers 206 do not specify any column fields, a default column field (e.g., “Total”) may be included in pivot table 500.

Pivot table 500 also includes row fields 504a-504c that respectively correspond to field identifiers 406a, 406b, and 406d of aggregated data set 400. Pivot table 500 further includes report filters 506a and 506b that respectively correspond to field identifiers 406f and 406c of aggregated data set 400.

Pivot table 500 also includes table entries 508. In particular embodiments, the table entries of pivot table 500 are generated according to data from an aggregated data set, such as aggregated data set 400. For example, a table entry 508 may correspond to a data value 404 of aggregated data set 400 or an aggregation of multiple data values 404 of aggregated data set 400. Multiple data values 404 may be aggregated in any suitable manner to generate a table entry 508. For example, an operation type indicated by an aggregation type 314b associated with the table entry 508 (e.g., associated with the field identifier 406 corresponding to the row the table entry is located in) may be performed.

Each table entry 508 may be associated with a particular column field (and, in some embodiments, a sub-column field) and row field. For example, table entry 508a is associated with column field 502, sub-column field 503a, and row field 504a; and entry 508b is associated with column field 502, sub-column field 503b, and row field 504b.

In some embodiments, the column fields 502 and row fields 504 may be interchangeable. Thus, a column field 502 may be transformed into a row field 504, and a row field 504 may be transformed into a column field 502. For example, an indication to transform a column field 502 into a row field 504 may be received (e.g., via a user interface associated with the pivot table 500), and the pivot table may be adjusted accordingly by a deletion of the row field 504 and an addition of a column field that corresponds to the same field identifier that the previous row field 504 corresponded to. The table entries 508 may then be updated accordingly. A similar process may be performed when a column field 502 is transformed into a row field 504.

Pivot table 500 may be stored at any suitable location. For example, pivot table 500 may be stored in memory 148 of computing system 108. In a particular embodiment, pivot table 500 is stored by a worksheet within a workbook that includes user interface 300. In other particular embodiments, a new file, such as a workbook, may be created to store pivot table 500.

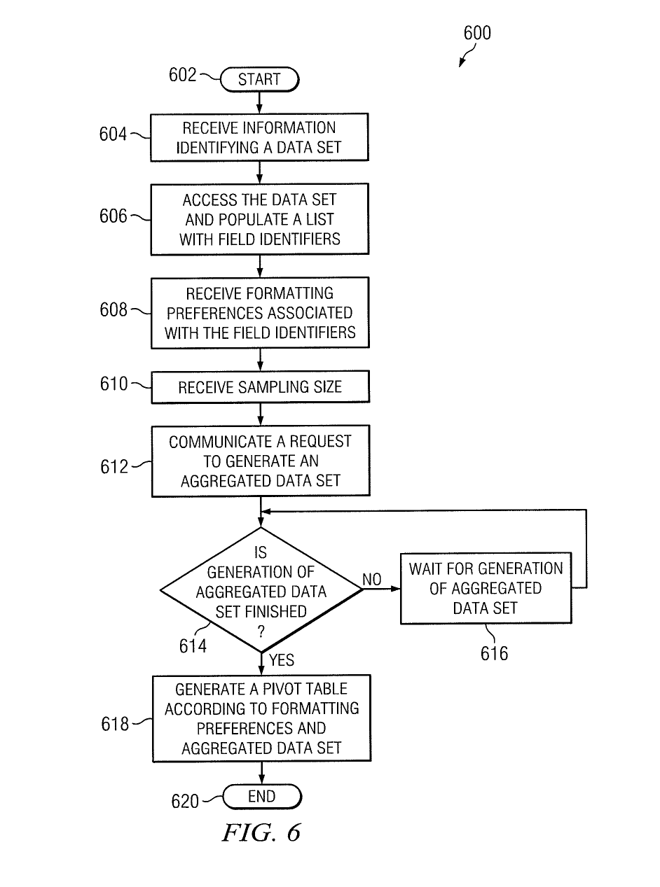

FIG. 6 illustrates an example method 600 for facilitating the generation of a pivot table 500 from an aggregated data set 400. The method begins at step 602. At step 604, computing system 108 receives information identifying a data set 200. The information may include a location and file name of data set 200. The information may also indicate whether data set 200 is stored on the computing system 108 or on a remote server or database. At step 604, data set 200 is accessed and a list of field identifiers 206 of data set 200 is populated. In some embodiments, the list is presented to a user through a user interface implemented by computing system 108. At step 608, formatting preferences associated with the field identifiers 206 are received. In some embodiments, the formatting preferences may be received through the user interface implemented by computing system 108. The formatting preferences may specify an arrangement within a pivot table 500 of information associated with field identifiers 206.

At step 610, a sampling size is received. In some embodiments, the sampling size may be received through the user interface. In particular embodiments, the sampling size indicates a percentage of data entries 202 of data set 200 that will be analyzed to form an aggregated data set 400. In some embodiments, data set 200 may be randomly sampled according to the sampling size.

At step 612, computing system 108 communicates a request to generate an aggregated data set 400. In some embodiments, the request is communicated to aggregation module 104. In other embodiments, the request is communicated within computing system 108. At step 614, computing system 108 determines whether the generation of aggregated data set 400 is finished. For example, computing system 108 may receive a message from aggregation module 104 indicating whether the aggregated data set 400 has been generated. If the generation of the aggregated data set 400 is not finished, computing system 108 waits for the aggregated data set 400 to be generated at step 616. Step 614 may then be repeated. Once the aggregated data set 400 is generated, the method moves to step 618.

At step 618, computing system 108 generates pivot table 500 according to the formatting preferences and aggregated data set 400. In particular embodiments, the column fields 502, row fields 504, report filters 506, and/or other formatting properties of the pivot table 500 are specified by the formatting preferences. The pivot table 500 may present the data of the aggregated data set 400 in a user-friendly manner.

Modifications, additions, or omissions may be made to method 600. The method may include more, fewer, or other steps. Additionally, steps may be performed in parallel or in any suitable order. Any suitable component of system 100 may perform one or more steps of method 600. The method ends at step 620.

Certain embodiments of the invention may provide one or more technical advantages. A technical advantage of one embodiment includes determining a plurality of field identifiers of a data set and receiving formatting preferences associated with the field identifiers. Another advantage includes aggregating a data set based on formatting preferences associated with the field identifiers of the data set. Another advantage includes generating a pivot table based on the aggregated data set.

Certain embodiments of the present disclosure may include some, all, or none of the above advantages. One or more other technical advantages may be readily apparent to those skilled in the art from the figures, descriptions, and claims included herein.

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the scope of the appended claims.

What is claimed is:

1. An apparatus, comprising:
an interface operable to:
receive a first request to access a data set comprising a first plurality of data entries, a data entry comprising one or more data values, a data value associated with a field identifier of a plurality of field identifiers;
a processor operable to:
determine the plurality of field identifiers of the data set;
wherein the interface is further operable to:
receive a plurality of formatting preferences associated with the plurality of field identifiers;
communicate a request to generate a first aggregated data set comprising an aggregation of two or more data entries of the first plurality of data entries, the aggregation based on the plurality of formatting preferences; and
wherein the processor is further operable to:
generate a first pivot table according to the formatting preferences and the aggregated data set, the first pivot table comprising at least one column field, a plurality of row fields, and a plurality of table entries, each table entry associated with a particular column field and a particular row field.

2. The apparatus of claim 1, wherein the first aggregated data set is generated from a first random sampling of the data entries of the data set.

3. The apparatus of claim 2, wherein:
the interface is further operable to:
request a generation of a second aggregated data set comprising an aggregation of two or more data entries of a second random sampling of the first plurality of data entries, the second random sampling comprising more data entries than the first random sampling; and
the processor is further operable to:
generate a second pivot table according to the second aggregated data set.

4. The apparatus of claim 1, wherein a particular column field of the plurality of column fields may be transformed into a row field and a particular row field of the plurality of row fields may be transformed into a column field.

5. The apparatus of claim 1, wherein the preferences indicate that a particular field identifier be represented in the pivot table as a row field and a report filter.

6. The apparatus of claim 5, wherein the preferences indicate a plurality of ranges of values associated with the particular field identifier and each range of values is a selectable value of the report filter of the pivot table.

7. The apparatus of claim 1, wherein the first aggregated data set is stored on a first computing system that is coupled through a network to a second computing system that includes the processor.

8. The apparatus of claim 1, wherein the first aggregated data set is stored by a spreadsheet application executed by the processor.

9. A non-transitory computing system readable medium comprising logic, the logic, when executed by a processor, operable to:
receive a first request to access a data set comprising a first plurality of data entries, a data entry comprising one or more data values, a data value associated with a field identifier of a plurality of field identifiers;
determine the plurality of field identifiers of the data set;
receive a plurality of formatting preferences associated with the plurality of field identifiers;
communicate a request to generate a first aggregated data set comprising an aggregation of two or more data entries of the first plurality of data entries, the aggregation based on the plurality of formatting preferences; and
generate a first pivot table according to the formatting preferences and the aggregated data set, the first pivot table comprising at least one column field, a plurality of row fields, and a plurality of table entries, each table entry associated with a particular column field and a particular row field.

10. The computing system readable medium of claim 9, wherein the first aggregated data set is generated from a first random sampling of the data entries of the data set.

11. The computing system readable medium of claim 10, wherein the logic is further operable to:
request a generation of a second aggregated data set comprising an aggregation of two or more data entries of a second random sampling of the first plurality of data entries, the second random sampling comprising more data entries than the first random sampling; and
generate a second pivot table according to the second aggregated data set.

12. The computing system readable medium of claim 9, wherein the logic is further operable to transform a particular column field of the plurality of column fields into a row field and transform a particular row field of the plurality of row fields into a column field.

13. The computing system readable medium of claim 9, wherein the preferences indicate that a particular field identifier be represented in the pivot table as a row field and a report filter.

14. The computing system readable medium of claim 13, wherein the preferences indicate a plurality of ranges of values associated with the particular field identifier and each range of values is a selectable value of the report filter of the pivot table.

15. The computing system readable medium of claim 9, wherein the first aggregated data set is stored on a first computing system that is coupled through a network to a second computing system that includes the processor.

16. The computing system readable medium of claim 9, wherein the first aggregated data set is stored by a spreadsheet application executed by the processor.

17. A method, comprising:
receiving a first request to access a data set comprising a first plurality of data entries, a data entry comprising one or more data values, a data value associated with a field identifier of a plurality of field identifiers;
determining, by a processor, the plurality of field identifiers of the data set;
receiving a plurality of formatting preferences associated with the plurality of field identifiers;
communicating a request to generate a first aggregated data set comprising an aggregation of two or more data entries of the first plurality of data entries, the aggregation based on the plurality of formatting preferences; and
generating, by the processor, a first pivot table according to the formatting preferences and the aggregated data set, the first pivot table comprising at least one column field, a plurality of row fields, and a plurality of table entries, each table entry associated with a particular column field and a particular row field.

18. The method of claim 17, wherein the first aggregated data set is generated from a first random sampling of the data entries of the data set.

19. The method of claim 18, further comprising:
requesting a generation of a second aggregated data set comprising an aggregation of two or more data entries of a second random sampling of the first plurality of data entries, the second random sampling comprising more data entries than the first random sampling; and
generating a second pivot table according to the second aggregated data set.

20. The method of claim 17, wherein a particular column field of the plurality of column fields may be transformed into a row field and a particular row field of the plurality of row fields may be transformed into a column field.

21. The method of claim 17, wherein the preferences indicate that a particular field identifier be represented in the pivot table as a row field and a report filter.

22. The method of claim 21, wherein the preferences indicate a plurality of ranges of values associated with the particular field identifier and each range of values is a selectable value of the report filter of the pivot table.

23. The method of claim 17, wherein the first aggregated data set is stored on a first computing system that is coupled through a network to a second computing system that includes the processor.

24. The method of claim 17, wherein the first aggregated data set is stored by a spreadsheet application executed by the processor.
